(19) United States
(12) Patent Application Publication
(10) Pub. No.: US 2012/0112719 A1
(43) Pub. Date: May 10, 2012

(54) RECTIFIER CIRCUIT

(75) Inventors: Chun-Hua XIA, SHANGHAI (CN); Tze-Hsin PENG, TAIPEI CITY (TW)

(73) Assignee: INVENTEC CORPORATION, TAIPEI CITY (TW)

(21) Appl. No.: 13/015,597

(22) Filed: Jan. 28, 2011

(30) Foreign Application Priority Data
Nov. 8, 2010 (CN) 201010539649.2

(51) Int. Cl. G05F 1/10

(52) U.S. Cl. 323/282

(57) ABSTRACT

A rectifier circuit includes: a switching circuit having an input end, an output terminal and a control end, wherein the input end of the switching circuit receives an input voltage; a control circuit electrically connected to the control end of the switching circuit, wherein, when a load current is smaller than a reference current, the rectifier circuit is situated at a light-load state and the control circuit reduces a switching frequency of the switching circuit; and a filtering circuit which is electrically connected between the output end of the switching circuit and an output terminal of the rectifier circuit, and includes at least one inductive component of which a current is formed by superposition of the load current and a ripple current, wherein, when the load current is smaller than the reference current, an inductance of the inductive component increases with the decrease of the load current.

### RELATED APPLICATIONS

This application claims priority to China Application Serial Number 201010539649.2, filed Nov. 8, 2010, which is herein incorporated by reference.

### BACKGROUND

1. Field of Invention

The present invention relates to a rectifier circuit. More particularly, the present invention relates to a rectifier circuit capable of improving a light-load efficiency and decreasing an amplitude of a ripple current.

2. Description of Related Art

Currently, all kinds of electronic products are designed with increasingly complicated functions, and various power source technologies are also developed at a high speed to meet the working requirements of the electronic products. At present, most of the electronic products adopt a switching power source including an AC/DC convertor, a DC/DC convertor and so on, and compared with a conventional linear power source, the switching power source has a distinctive advantage of high conversion efficiency, which may generally reach 80% or even 90% or above. However, a defect of this power source lies in that, when the power source stays in a high-frequency working state, the output ripple voltage is relatively large.

Among the existing switching power sources, a synchronous rectification BUCK switching power source is most widely used, which has the problem of a large ripple current caused by the factors of on/off of the MOSFET, electricity storage and discharge of an inductive element and charge/discharge of a capacitor, and the problem inevitably results in a large noise occurring at an output end of the switching power source; or the reduction of the voltage output efficiency. In addition, the switching power source also has to satisfy the electricity demands of its applicable electronic equipment in different working situations. Taking a server as an example, when the server is situated at a high-speed operation state or at a standby state for a long time, respectively, the synchronous rectification BUCK switching power source also needs to respectively satisfy the heavy-load and light-load efficiencies, so as to achieve energy saving and consumption reducing.

At present, a method for reducing a switching frequency of the switching power source is commonly adopted in this field to improve a light-load efficiency of the power source. However, although the reduction of switching frequency may reduce the switching loss, yet it causes the increase of the turn-on time of the switch, which aggravates the generation of a ripple voltage of the power source and consequently causes more power consumption. To overcome the above defects, a solution in the prior art is to add more capacitors to the switching power source so as to decrease the ripple voltage, which adversely increases the production cost.

Therefore, there is a need to provide a novel rectification system having a switching circuit for not only maintaining a light-load efficiency of a direct-current power supplier but also decreasing a ripple voltage component in an output voltage.

### SUMMARY

In view of the above, the present invention aims to provide a rectifier circuit for improving a light-load frequency down-conversion efficiency and meanwhile decreasing a ripple voltage.

According to an aspect of the present invention, a rectifier circuit is provided, wherein an output terminal of the rectifier circuit is electrically connected to a load, and the rectifier circuit outputs an output voltage to the load according to an input voltage and generates a load current according to the load. The rectifier circuit includes:

a switching circuit having an input end, an output end and a control end, wherein the input end of the switching circuit receives the input voltage;

a control circuit electrically connected to the control end of the switching circuit, for controlling a pulse width of the switching circuit to regulate the output voltage, wherein, when the load current is smaller than a reference current, the rectifier circuit is situated at a light-load state, and the control circuit reduces a switching frequency of the switching circuit, thereby reducing a switching loss of the switching circuit; and

a filtering circuit electrically connected between the output end of the switching circuit and the output terminal of the rectifier circuit, the filtering circuit including at least one inductive component of which a current is formed by superposition of the load current and a ripple current, wherein, when the load current is smaller than the reference current, an inductance of the inductive component increases with the decrease of the load current, thereby decreasing an amplitude of the ripple current and further decreasing a ripple of the output voltage.

Preferably, the control circuit includes: a comparison circuit electrically connected to the filtering circuit, for comparing the load current with the reference current, wherein, if the load current is greater than the reference current, the comparison circuit outputs a first comparison signal; and if the load current is smaller than the reference current, the comparison circuit outputs a second comparison signal; and a signal generating circuit receiving the first comparison signal or the second comparison signal, wherein, when receiving the first comparison signal, the signal generating circuit outputs a first control signal to the control end of the switching circuit; and when receiving the second comparison signal, the signal generating circuit outputs a second control signal to the control end of the switching circuit, wherein a frequency of the second control signal is lower than a frequency of the first control signal. Furthermore, the comparison circuit further includes a current sensing circuit electrically connected to the filtering circuit, for sensing the load current.

In an embodiment, the current sensing circuit amplifies n times a value of the load current. The comparison circuit further includes a comparator, wherein a first input end of the comparator receives the load current which is amplified; a second input end of the comparator is electrically connected to a current source; a value of a current outputted by the current source is n times as much as the value of the reference current; and an output end of the comparator outputs the first comparison signal or the second comparison signal. Moreover, the first input end of the comparator is a positive phase input end, and the second input end of the comparator is a negative phase input end. Furthermore, the first comparison signal is at a first level and the second comparison signal is at a second level.

Preferably, the signal generating circuit further includes a clock generating circuit for receiving the first comparison signal or the second comparison signal, wherein, when receiving the first comparison signal, the clock generating circuit outputs a first clock signal; and when receiving the second comparison signal, the clock generating circuit outputs a second clock signal, wherein a frequency of the second clock signal is lower than a frequency of the first clock signal; and a pulse width modulation circuit for receiving the first clock signal or the second clock signal and generating the first control signal or the second control signal correspondingly according to the first clock signal or the second clock signal. Furthermore, the control circuit further includes an error amplification circuit electrically connected between the output terminal of the rectifier circuit and the pulse width modulation circuit, for amplifying an error value between the output voltage and a reference output voltage and transmitting the error value to the pulse width modulation circuit. The pulse width modulation circuit further regulates a pulse width of the first control signal or the second control signal according to the error value outputted by the error amplification circuit, so as to regulate the output voltage.

Preferably, the switching circuit includes a first transistor and a second transistor complementary to each other. The control end of the switching circuit is connected to a control electrode of the first transistor via a first driver, and the control end of the switching circuit is connected to a control electrode of the second transistor via a second driver, so as to selectively actuate the first transistor or the second transistor. Furthermore, each of the first transistor and the second transistor has a freewheeling diode. In addition, when the first transistor is turned on, the output end of the switching circuit outputs the input voltage; and when the second transistor is turned on, the output end of the switching circuit outputs a grounding voltage.

Therefore, when being adopted, the rectifier circuit of the present invention does not need an additional capacitor element, and can not only improve a light-load frequency down-conversion efficiency of a power supplier but also effectively reduce a ripple voltage component in an output voltage of the rectifier circuit.

### BRIEF DESCRIPTION OF THE DRAWINGS

The present invention can be more fully understood by reading the following detailed description of the embodiments, with reference made to the accompanying drawings as follows:

FIG. 1 is a block diagram illustrating the connections of respective functional modules in a rectifier circuit according to a preferred embodiment of the present invention;

FIG. 2A, FIG. 2B and FIG. 2C are schematic views of a ripple current generated by a filtering circuit in a conventional rectifier circuit;

FIG. 3A and FIG. 3B are schematic views of a ripple current generated by a filtering circuit in the rectifier circuit of the present invention;

FIG. 4 is a structural block diagram showing a specific embodiment of a control circuit in the rectifier circuit of FIG. 1; and

FIG. 5 is a schematic view showing a circuit principle of the rectifier circuit of FIG. 1.

### DETAILED DESCRIPTION

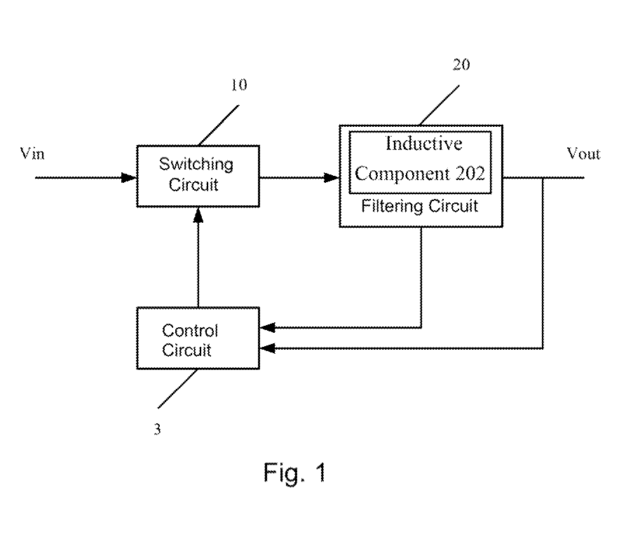

FIG. 1 is a block diagram illustrating the connections of respective functional modules in a rectifier circuit according to a preferred embodiment of the present invention. Referring to FIG. 1, the rectifier circuit includes a switching circuit 10, a filtering circuit 20 and a control circuit 3. The switching circuit 10 has an input end, an output end and a control end, wherein the input end is used for receiving an input voltage Vin, and the output end is electrically connected to the filtering circuit 20, and the control end is electrically connected to the control circuit 3. The switching circuit 10 is controlled by a pulse width modulation signal outputted by the control circuit 3.

The control circuit 3 is electrically connected between the control end of the switching circuit 10 and an output terminal Vout of the rectifier circuit for controlling the pulse width modulation signal of the switching circuit, thereby regulating the output voltage. Particularly, when a load current is smaller than a reference current, the rectifier circuit a light-load state, and the control circuit 3 reduces a switching frequency of the switching circuit 10, thereby reducing a switching loss of the switching circuit 10. However, when the switching frequency of the switching circuit 10 is reduced, an amplitude of a ripple current increases. In the rectifier circuit of FIG. 1, its output terminal is electrically connected to a load, and outputs a voltage Vout to the load according to the input voltage Vin, so as to generate a load current. Moreover, the load current may be fed to the control circuit 3 so as to be compared with a preset reference current.

The filtering circuit 20 is electrically connected between the output end of the switching circuit 10 and the output terminal Vout of the rectifier circuit, and the filtering circuit 20 includes at least one inductive component 202 of which a current is formed by superposition of the load current and the ripple current. More specifically, when the load current is smaller than the reference current, an inductance of the inductive component 202 adopted by the present invention increases with the decrease of the load current, thereby decreasing the amplitude of the ripple current and further decreasing a ripple component of the output voltage Vout. Therefore, in the circumstance that the load current is smaller than a light load of the reference current, although the control circuit 3 increases the amplitude of the ripple current while reducing the switching is frequency of the switching circuit 10, the inductive component 202 in the filtering circuit 20 can reduce the amplitude of the ripple current.

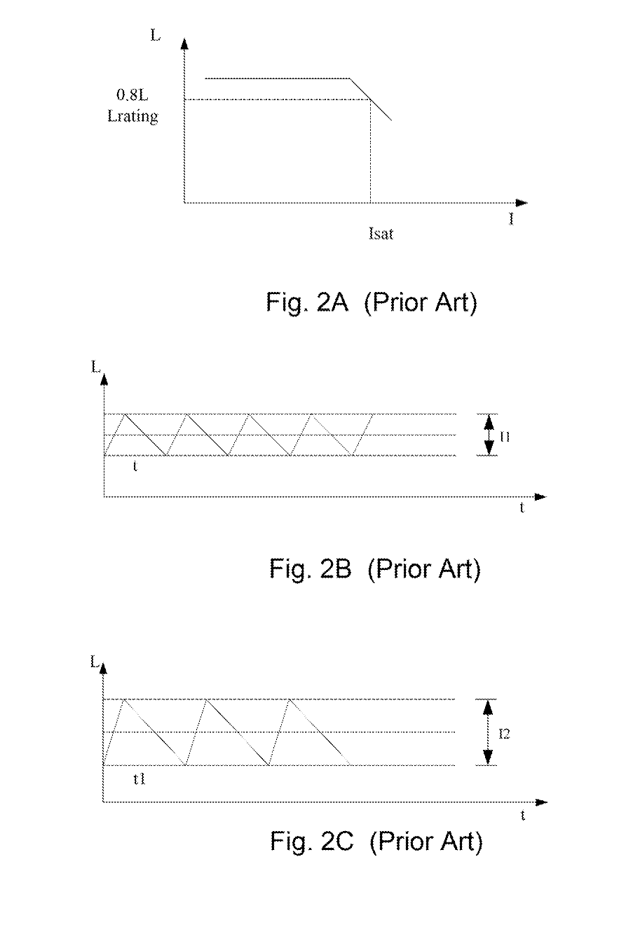

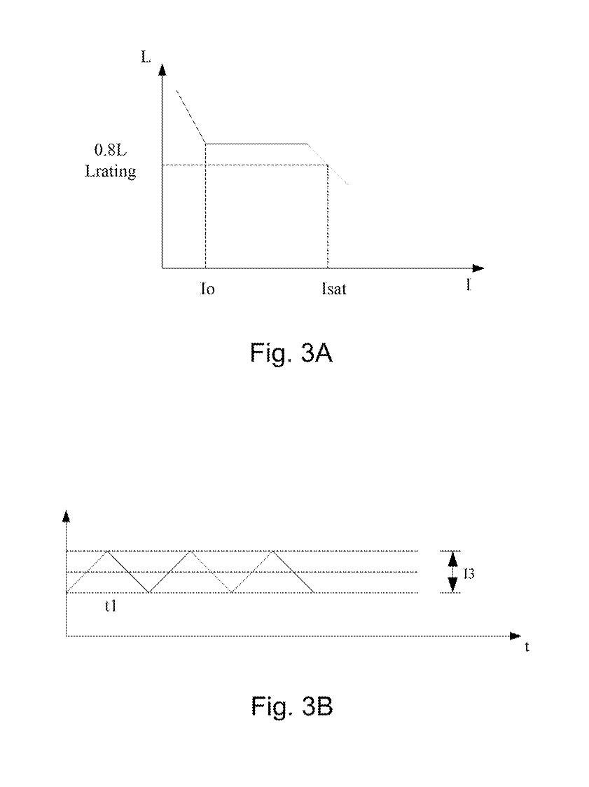

For more visually understanding that the filtering circuit of the present invention has a lower ripple current as compared with a ripple current generated by a conventional filtering circuit. In the following paragraphs, the details of comparison between the current waveforms are illustrated to explain the design scheme of the present invention for reducing the ripple current. FIG. 2A, FIG. 2B and FIG. 2C are schematic views of a ripple current generated by a filtering circuit in a conventional rectifier circuit, and FIG. 3A and FIG. 3B are schematic views of a ripple current generated by a filtering circuit in the rectifier circuit of the present invention.

Generally speaking, when a load current is smaller than a reference current and the switching power source is situated at a light-load state, the switching loss of the switching circuit is in direct proportion to the switching frequency. Therefore, those of ordinary skills in the art should understand that the reduction of the switching frequency of the switching circuit can improve the light-load efficiency. That is, a clock control signal is used for controlling and reducing the switching frequency of the switching circuit and further improving the light-load efficiency of the rectifier circuit. It should also be noted that, when the switching power source is situated at the light-load state, the load current of the switching power source decreases, which results in that the load voltage of the switching power source is reduced to a certain range. There is an inductance formula: V=L*di/dt, where V is a load voltage when the switching power source has a light load; L is an inductance of the inductive element; di is a ripple voltage generated by the inductive element; and dt is a time cycle of the switching circuit. According to this formula, the inductive element generates a ripple current I1 at a lit frequency (as shown in FIG. 2B), and when the values of V and t remain unchanged, the ripple current value I1 generated by the inductive element remains unchanged.

Referring to FIG. 2C, when the switching power source is situated the light-load state, the switching frequency of the switching circuit is reduced at the same time, and the switching circuit works at a constant time cycle t1, and the time cycle t1 is greater than the above time cycle t. Similarly, according to the inductance formula: V=L*di/dt, when the value of V remains unchanged, the value of L remains unchanged; and when the value of dt becomes greater, di increases. That is, the ripple voltage generated by the inductive element increases (the ripple current I2 is greater than the ripple current I1).

As can be known from FIG. 2B and FIG. 2C, although the light-load efficiency of the system can be improved by reducing the switching frequency of the switching circuit, yet when the switching frequency is reduced, the time cycle becomes longer correspondingly. In the circumstance that the duty ratio remains unchanged, the turn-on time of the switching circuit is increased, which results in the increase of the charging time for the inductor, thus adversely causing the increase of the ripple current (12) of the inductor according to the formula V=L*di/dt.

To solve the above technical problem, FIG. 3A and FIG. 3B are schematic views of a ripple current generated by a filtering circuit in the rectifier circuit of the present invention. Generally speaking, the inductance of the inductive element remains unchanged in a certain range of the load current value, but when the load current value of the inductive element exceeds a fixed value, e.g. an inductance corresponding to Isat on the current coordinates, it is known that the inductance of the inductive element becomes smaller and is reduced to 80% of the rated inductance. Furthermore, when the load current flowing through the inductive component 202 of the present invention is smaller than a reference current Io, the inductance of the inductive component is increased correspondingly. Likewise, please refer to the inductance formula V=L*di/dt, where V is a load voltage of the inductive element; L is an inductance of the inductive element; dt is a time cycle of the switching circuit; and di is a ripple voltage 13 generated by the inductive element. As a result, in the circumstance that the same frequency, cycle and turn-on time are provided, i.e. when the load voltage V remains unchanged and dt remains unchanged, the greater the inductance L is, the smaller di is (i.e. the ripple current I3 of the inductor becomes smaller), thereby reducing the corresponding ripple voltage.

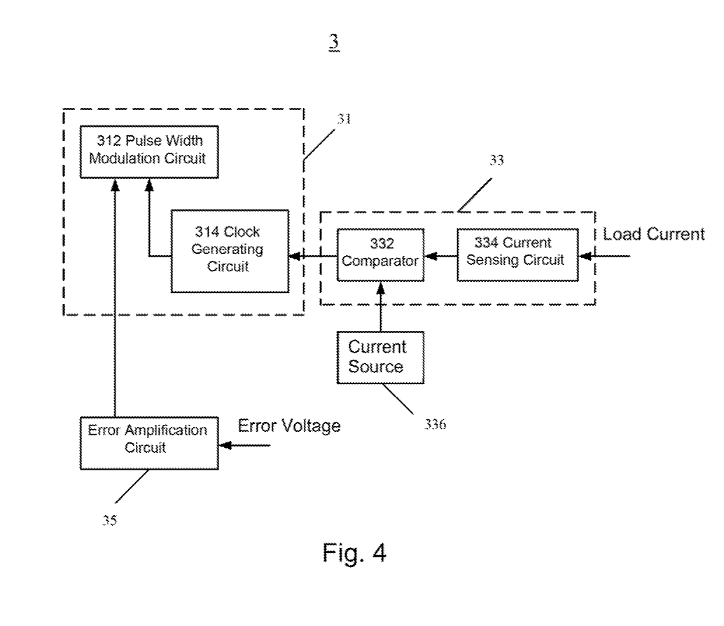

FIG. 4 is a structural block diagram showing a specific embodiment of a control circuit in the rectifier circuit of FIG. 1. Referring to FIG. 4, the control circuit 3 includes a signal generating circuit 31 and a comparison circuit 33.

As described above, the comparison circuit 33 is electrically connected to the filtering circuit 20, for comparing the load current with a reference current from the current source; outputting a first comparison signal when the load current is greater than the reference current; and outputting a second comparison signal when the load current is smaller than the reference current.

The signal generating circuit 31 is electrically connected to the comparison circuit 33 and the switching circuit 10, and the comparison circuit 33 is electrically connected to the filtering circuit 20 and the signal generating circuit 31. More specifically, the signal generating circuit 31 receives a comparison result from the comparison circuit 33, the comparison result including a first comparison signal and a second comparison signal. For example, when receiving the first comparison signal, the signal generating circuit 31 outputs a first control signal to the control end of the switching circuit 10; and when receiving the second comparison signal, the signal generating circuit 31 outputs a second control signal to the control end of the switching circuit 10, wherein a frequency of the second control signal is lower than a frequency of the first control signal.

According to an embodiment, the comparison circuit 33 includes a comparator 332 and a current sensing circuit 334. The current sensing circuit 334 is electrically connected to the filtering circuit 20, for sensing a load current formed at a load end. Preferably, the current sensing circuit 334 amplifies n times a value of the load current, and a first input end (a positive phase input end) of the comparator 332 receives the load current which is amplified. Meanwhile, a second input end (a negative phase input end) of the comparator 332 is electrically connected to a current source 336, and the output current value is set to be n times as much as a value of the reference current. Thus, the n times of the load current is compared with the n times of the reference current, and an output end of the comparator 332 outputs the first comparison signal or the second comparison signal. For example, the first comparison signal is at a first level and the second comparison signal is at a second level. Those of ordinary skills in the art should understand that, in the circuit connection as shown in FIG. 4, the load current is introduced from the positive phase input end of the comparator 332; the reference current is introduced from the negative phase input end of the comparator 332; and the first comparison signal and the second comparison signal are outputted correspondingly, but the present invention is not limited thereto. For example, the load current may also be introduced from the negative phase input end of the comparator 332, and the reference current may also be introduced from the positive phase input end of the comparator 332, and accordingly the type of the level of a comparison signal outputted by the comparator is changed.

According to another embodiment, the signal generating circuit 31 includes a pulse width modulation circuit 312 and a clock generating circuit 314. The clock generating circuit 314 receives the first comparison signal or the second comparison signal from the comparison circuit 33. When receiving the first comparison signal, the clock generating circuit 314 outputs a first clock signal; and when receiving the second comparison signal, the clock generating circuit 314 outputs a second clock signal, wherein a frequency of the second clock signal is lower than a frequency of the first clock signal. The pulse width modulation circuit 312 is electrically connected to the clock generating circuit 314; for receiving the first clock signal or the second clock signal and generating a first control signal or a second control signal correspondingly according to the first clock signal or the second clock signal. Since the frequency of the second clock signal is lower than that of the first clock signal, a frequency of the second control signal is correspondingly lower than a frequency of the first control signal. Moreover, the control circuit 3 further includes an error amplification circuit 35. The error amplification circuit 35 is electrically connected between the output terminal of the rectifier circuit and the pulse width modulation circuit 312, for amplifying an error value between the output voltage of the rectifier is circuit and a reference output voltage, and transmitting the error value to the pulse width modulation circuit 312. Correspondingly, the pulse width modulation circuit 312 further regulates a pulse width of the first control signal or the second control signal according to the error value outputted by the error amplification circuit 35.

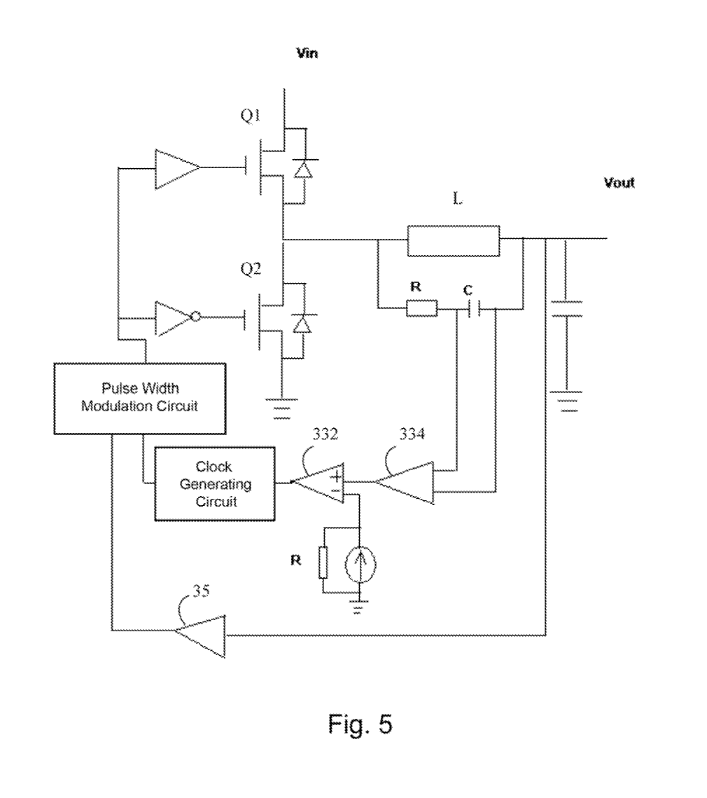

FIG. 5 is a schematic view showing a circuit principle of the rectifier circuit of FIG. 1. Referring to both FIG. 4 and FIG. 5, the control circuit 3 of the rectifier circuit has been described in detail based on the comparison current 33 and the signal generating current 31, so that the details will not be repeated herein. In an embodiment, with regard to the switching circuit 10, its input end is electrically connected to the input voltage Vin of the rectifier circuit, and its output end is electrically connected to the filtering circuit 20, and its control end is electrically connected to an output end of the pulse width modulation circuit 312 of the signal generating circuit 31. The switching circuit 10 includes a transistor Q1 and a transistor Q2 complementary to each other, wherein the control end of the switching circuit 10 is connected to a control electrode (i.e. a gate) of the transistor Q1 via a first driver (e.g. a buffer), and the control end of the switching circuit 10 is connected to a control electrode (i.e. a gate) of the transistor Q2 via a second driver (e.g. an inverting buffer). In this way, the transistor Q1 or the transistor Q2 may be selectively actuated by a control signal outputted by the pulse width modulation circuit 312.

Preferably, each of the transistor Q1 and the transistor Q2 has a freewheeling diode. Moreover, when the transistor Q1 is turned on, the output end of the switching circuit 10 outputs the input voltage; and when the transistor Q2 is turned on, the output end of the switching circuit 10 outputs a grounding voltage.

When being adopted, the rectifier circuit of the present invention does not need an additional capacitor element, and can not only improve the light-load frequency reduction efficiency of a power supplier but also effectively reduce the ripple voltage component in the output voltage of the rectifier circuit. Although the embodiments of the present invention have been described with reference to the accompanying drawings, it will be apparent to those skilled in the art that various modifications and variations can be made without departing from the scope or spirit of the present invention. Such modifications and variations shall fall within the scope as defined by the appended claims.

What is claimed is:

1. A rectifier circuit having an output terminal electrically connected to a load, wherein the rectifier circuit outputs an output voltage to the load according to an input voltage and generates a load current according to the load, the rectifier circuit comprising:
a switching circuit having an input end, an output end and a control end, wherein the input end of the switching circuit receives the input voltage;
a control circuit electrically connected to the control end of the switching circuit, for controlling a pulse width of the switching circuit to regulate the output voltage, wherein, when the load current is smaller than a reference current, the rectifier circuit is situated at a light-load state and the control circuit reduces a switching frequency of the switching circuit, thereby reducing a switching loss of the switching circuit; and
a filtering circuit electrically connected between the output end of the switching circuit and the output terminal of the rectifier circuit, the filtering circuit comprising at least one inductive component of which a current is formed by superposition of the load current and a ripple current, wherein, when the load current is smaller than the reference current, an inductance of the inductive component increases with the decrease of the load current, thereby decreasing an amplitude of the ripple current and further decreasing a ripple of the output voltage.

2. The rectifier circuit of claim 1, wherein the control circuit comprises:
a comparison circuit electrically connected to the filtering circuit, for comparing the load current with the reference current, wherein, if the load current is greater than the reference current, the comparison circuit outputs a first comparison signal; and if the load current is smaller than the reference current, the comparison circuit outputs a second comparison signal; and
a signal generating circuit for receiving the first comparison signal or the second comparison signal, wherein, when receiving the first comparison signal, the signal generating circuit outputs a first control signal to the control end of the switching circuit; and when receiving the second comparison signal, the signal generating circuit outputs a second control signal to the control end of the switching circuit, wherein a frequency of the second control signal is lower than a frequency of the first control signal.

3. The rectifier circuit of claim 2, wherein the comparison circuit further comprises a current sensing circuit electrically connected to the filtering circuit, for sensing the load current.

4. The rectifier circuit of claim 3, wherein the current sensing circuit amplifies n times a value of the load current; the comparison circuit further comprises a comparator; a first input end of the comparator receives the load current which is amplified; a second input end of the comparator is electrically connected to a current source; a value of a current outputted by the current source is n times as much as a value of the reference current; and an output end of the comparator outputs the first comparison signal or the second comparison signal, wherein the n is a natural number.

5. The rectifier circuit of claim 4, wherein the first input end of the comparator is a positive phase input end, and the second input end of the comparator is a negative phase input end.

6. The rectifier circuit of claim 4, wherein the first comparison signal is a first level, and the second comparison signal is a second level.

7. The rectifier circuit of claim 2, wherein the signal generating circuit further comprises:
a clock generating circuit receiving the first comparison signal or the second comparison signal, wherein, when receiving the first comparison signal, the clock generating circuit outputs a first clock signal; and when receiving the second comparison signal, the clock generating circuit outputs a second clock signal, wherein a frequency of the second clock signal is lower than a frequency of the first clock signal; and
a pulse width modulation circuit receiving the first clock signal or the second clock signal, the pulse width modulation circuit generating the first control signal or the second control signal correspondingly according to the first clock signal or the second clock signal.

8. The rectifier circuit of claim 7, wherein the control circuit further comprises an error amplification circuit electrically connected between the output terminal of the rectifier circuit and the pulse width modulation circuit, for amplifying an error value between the output voltage and a reference output voltage and transmitting the error value to the pulse width modulation circuit, wherein the pulse width modulation circuit further regulates a pulse width of the first control signal or the second control signal according to the error value outputted by the error amplification circuit, so as to regulate the output voltage.

9. The rectifier circuit of claim 1, wherein the switching circuit comprises a first transistor and a second transistor complementary to each other, wherein the control end of the switching circuit is connected to a control electrode of the first transistor via a first driver, and the control end of the switching circuit is connected to a control electrode of the second transistor via a second driver, so as to selectively actuate the first transistor or the second transistor.

10. The rectifier circuit of claim 9, wherein each of the first transistor and the second transistor has a freewheeling diode, and when the first transistor is turned on, the output end of the switching circuit outputs the input voltage; and when the second transistor is turned on, the output end of the switching circuit outputs a grounding voltage.
